(19) United States
(12) Patent Application Publication
(10) Pub. No.: US 2013/0115866 A1
(43) Pub. Date: May 9, 2013

(54) COIN CHANGING SYSTEM

(71) Applicants: Hung-Yi Chang, TaiPei (TW); Dong-Ying Yang, TaiPei (TW)

(72) Inventors: Hung-Yi Chang, TaiPei (TW); Dong-Ying Yang, TaiPei (TW)

(21) Appl. No.: 13/668,750

(22) Filed: Nov. 5, 2012

(30) Foreign Application Priority Data
Nov. 4, 2011 (TW) 100140241

(51) Int. Cl. G07D 9/00

(52) U.S. Cl. 453/16; 453/63

(57) ABSTRACT

The invention discloses a coin changing system. The present invention is capable of sensing the coin storing condition of each of the plurality of the accommodating modules arranged in the matrix form of more than 2 rows and 2 columns simultaneously, without limiting the arrangement thereof. Furthermore, the unique design of the guiding component of the present invention is capable of avoiding the coins from getting jammed during the accommodating process thereof. Nevertheless, the present invention requires only one single motor to deal the coins of each of the plurality of the accommodating modules so as to minimize the size of the coin changing system of the present invention. Accordingly, the present invention overcomes the problems presented in the prior art by a relatively simple design.

### PRIORITY CLAIM

This application claims the benefit of the filing date of Taiwan Patent Application No. 100140241, filed Nov. 4, 2011, entitled “COIN CHANGING SYSTEM,” and the contents of which is hereby incorporated by reference in their entirety.

### FIELD OF THE INVENTION

The present invention relates to a coin changing system, and more particularly, to a coin changing system which processes high stability; moreover, the present invention further provides a novel design for detecting the stock of coins.

### BACKGROUND OF THE INVENTION

Since the fully automatic coin changing system was invented in 1960s, coin changing system has been renovated and improved constantly; however, there are still some problems needed to be solved.

For example, the conventional coin changing system judges the stock of coins by sensing the optical path; thus, a light-emitting unit and a sensing module are necessary to be respectively configured at the both sides of its coin-accommodating module, causing the increase of the size of the conventional coin changing systems and complicating the installation process thereof. Moreover, considering the optical design, the conventional systems cannot sense the coin storing condition of the accommodating modules arranged in the matrix form of more than 2 rows and 2 columns.

In addition, the accommodating module has piercings for plucking bars to penetrate through; however, coins often got stuck in the conventional coin changing system due to the oversized piercings. Besides, each motor processes coin-plucking process within only two accommodating modules; that is to say, the size of the conventional coin changing system must be increased when there are more motors configured in.

Accordingly, how to improve the problems mentioned above is a challenge.

### SUMMARY OF THE INVENTION

Therefore, a scope of the present invention is to provide a coin changing system for accommodating and changing a plurality of coins; the coin changing system of the present invention comprises a detecting apparatus and a separable apparatus. The detecting apparatus further comprises a light-emitting unit, a photo sensing unit, and an operation unit; wherein the light-emitting unit is utilized for generating a light beam, the photo sensing unit is utilized for sensing the light beam and generating a corresponding sensing signal, and the operation unit is utilized for judging the stock of coins in accordance with the sensing signal.

The separable apparatus is interconnected with the detecting apparatus and further comprises an accommodating module, a light-guiding module, and a reflection module; wherein the accommodating module is utilized for accommodating the plurality of coins, and the light-guiding module is used for building an optical interconnection between the light-emitting unit and the photo sensing unit. Furthermore, the reflection module is configured on the accommodating module and is used for changing the traveling direction of the light beam to allow the light beam to be returned into the light-guiding module.

In addition, the light-guiding module comprises a first light-guiding element and a second light-guiding element; wherein the first light-guiding element is used for guiding the light beam from the light-emitting unit into the reflection module, and the second light-guiding element is used for guiding the light beam outputted from the reflection module into the photo sensing unit.

In actual application, the first light-guiding element or the second light-guiding element may have a light-inputting end for receiving the light beam, and the light-inputting end has a focusing structure; moreover, the first light-guiding element or the second light-guiding element may further have a light-outputting end for outputting the light beam, and the light-outputting end has a focusing structure. To be noticed, the stretching orientation of the first light-guiding element or the second light-guiding element is the same with the stacking direction of the plurality of coins.

According to another scope of the present invention, the coin changing system comprises a plurality of accommodating modules and a coin-plucking apparatus; wherein the accommodating modules is utilized for accommodating the plurality of coins respectively, and the coin-plucking apparatus further comprises a plurality of plucking bars, a wheel disk, and a backstop structure. The plurality of plucking bars are used for plucking the coins inside the accommodating modules respectively, and the backstop structure is used for jointing the plucking bars and the wheel disk.

More specifically, when the wheel disk rotates forward to allow the backstop structure to be contacted with the coin-plucking apparatus and the wheel disk simultaneously, the backstop structure has a corresponding actuation so as to let the plucking bars be motionless; when the wheel disk rotates backward to allow the backstop structure to be contacted with the coin-plucking apparatus and the wheel disk simultaneously, the plucking bars is engaged with the wheel disk through the backstop structure. In actual application, the coin-plucking apparatus may further comprise a power module for providing a torque to the wheel disk, and the power module is connected with the wheel disk.

Additionally, in another scope of the present invention, the coin changing system comprises an accommodating module and a guiding component; wherein the accommodating module is utilized for accommodating the plurality of coins, and has a lateral wall portion and an outlet end. The guiding component is configured at the outlet end, and further has a bearing surface, a connecting structure, a first extension structure, a second extension structure, and a passage.

The bearing surface is used for bearing a coin; the first extension structure and the second extension structure are extended outward from the connecting structure; and the passage is formed between the first extension structure and the second extension structure to permit a plucking bar to pass through and pluck the coin. Moreover, the guiding component has a closure condition and an opening condition; in the closure condition, the width of the passage is less than the width of the plucking bar so as to prevent the plurality of coins from falling down; in the opening condition, the plucking bar is contacted with the first extension structure and the second extension structure so as to make the width of the passage larger than the width in the closure condition thereof.

In actual application, the connecting structure of the guiding component further comprises a horizontal withstanding portion, a vertical withstanding portion, and a coin-outputting space. The horizontal withstanding portion is utilized for providing a horizontal force to the lateral wall portion of the accommodating module; and the vertical withstanding portion is used for providing a vertical force to the outlet end of the accommodating module, and the vertical withstanding portion has a bottom surface. The coin-outputting space is configured under the connecting structure and at the corresponding level height of the first extension structure and the second extension structure, so that the coins can be output via the coin-outputting space.

Therefore, the coin changing system of the present invention is capable of sensing the coin storing condition of each of the plurality of the accommodating modules arranged in the matrix form of more than 2 rows and 2 columns simultaneously. Furthermore, the unique design of the guiding component of the present invention is capable of avoiding the coins from getting jammed during the accommodating process thereof. Nevertheless, the present invention requires only one single motor to deal the coins of each of the plurality of the accommodating modules so as to minimize the size of the coin changing system of the present invention.

Many other advantages and features of the present invention will be further understood by the detailed description and the accompanying sheet of drawings.

### BRIEF DESCRIPTION OF THE DRAWINGS

FIG. 1A is a functional block diagram illustrating a coin changing system according to an embodiment of the present invention.

FIG. 1B is a schematic diagram of an angle of view illustrating an embodiment of the present invention.

FIG. 1C is a schematic diagram of another angle of view illustrating an embodiment of the present invention.

FIG. 2A is a three-dimensional diagram illustrating a separable apparatus according to an embodiment of the present invention.

FIG. 2B is a schematic diagram illustrating each main component of the separable apparatus according to an embodiment of the present invention.

FIG. 2C is a schematic diagram of another angle of view illustrating each main component of the separable apparatus according to an embodiment of the present invention.

FIG. 3A is a schematic diagram illustrating the relative position of the coin-plucking apparatus and the guiding component according to an embodiment of the present invention.

FIG. 3B is a schematic diagram illustrating the operation of the coin-plucking apparatus according to an embodiment of the present invention.

FIG. 4A is a schematic diagram illustrating the guiding component according to an embodiment of the present invention.

FIG. 4B is a schematic diagram illustrating the guiding component in the closure condition according to an embodiment of the present invention.

FIG. 4C is a schematic diagram illustrating the guiding component in the opening condition according to an embodiment of the present invention.

FIG. 5A is a schematic diagram illustrating the relative position of each main component according to an embodiment of the present invention.

FIG. 5B is a top view illustrating the relative position of each main component according to an embodiment of the present invention.

To facilitate understanding, identical reference numerals have been used, where possible to designate identical elements that are common to the figures.

### DETAILED DESCRIPTION

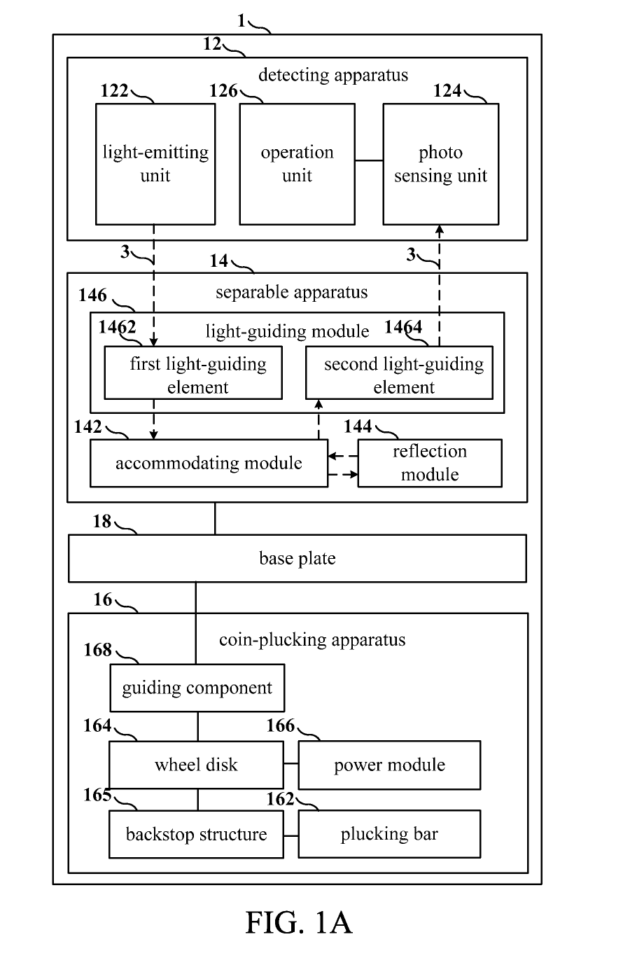

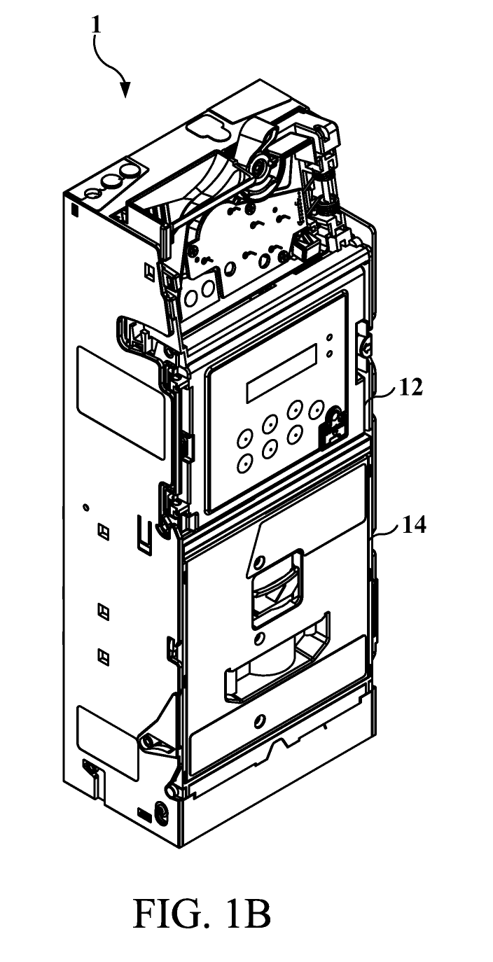

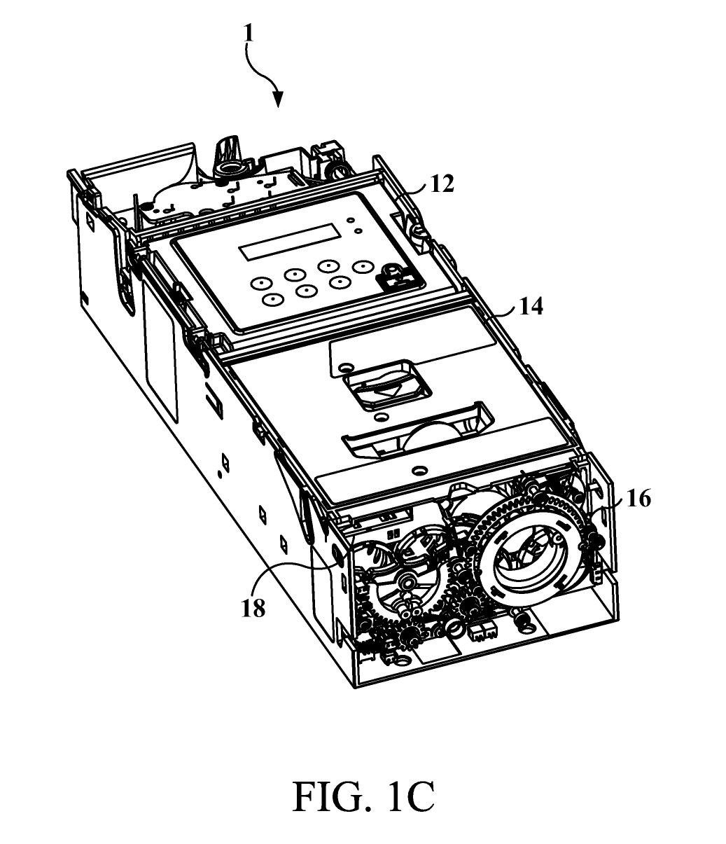

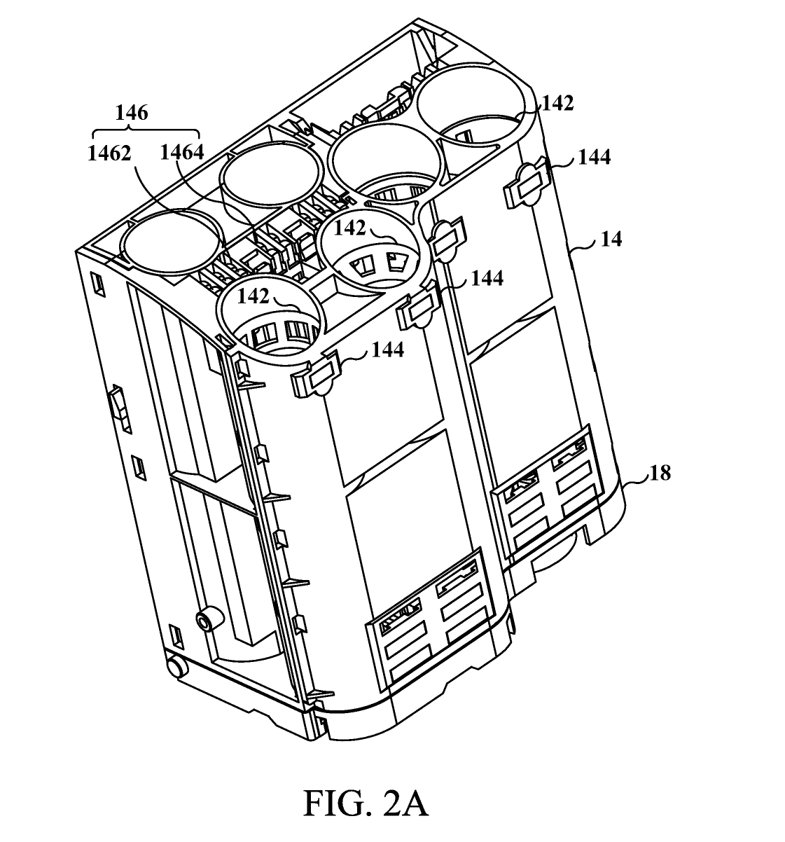

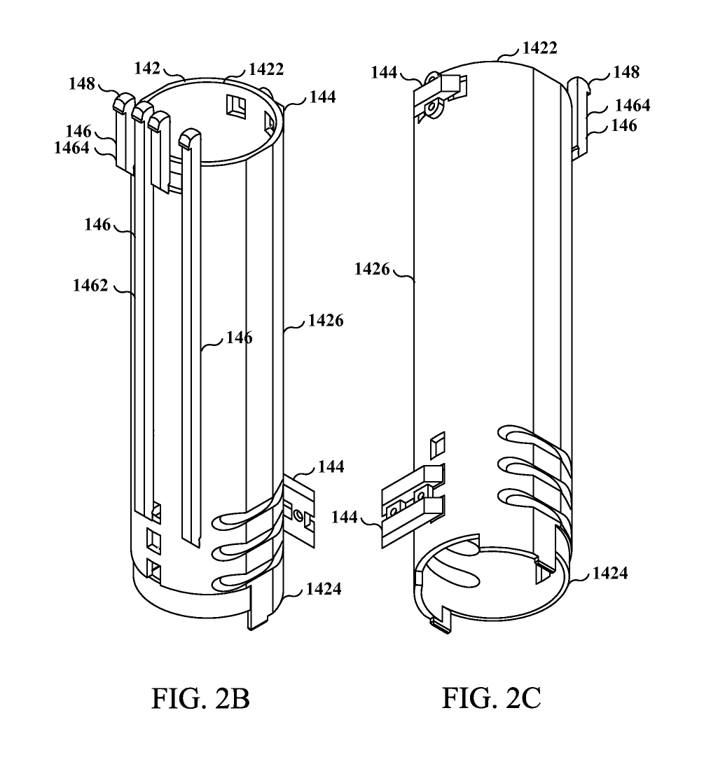

Please refer to FIG. 1A to 1C and FIG. 2A to 2C. FIG. 1A is a functional block diagram illustrating a coin changing system according to an embodiment of the present invention. FIGS. 1B and 1C are the schematic diagram of each angle of view illustrating an embodiment of the present invention.

The invention discloses a system for classifying tiny insects. Please refer to FIG. 1. FIG. 1 is a schematic diagram illustrating a system for classifying tiny insects 1 according to an embodiment of the invention. As shown in FIG. 1, the system for classifying tiny insects 1 comprises a cultivation tank 10, a detecting container 12, a detector 14, a control unit 16, and a gathering device 18. FIG. 2A is a three-dimensional diagram illustrating a separable apparatus according to an embodiment of the present invention. FIGS. 2B and 2C are the schematic diagram illustrating each main component of the separable apparatus with different angles of view. To be noticed, the proportion and the relative position of the components in these figures are identical with actual situation.

As shown in FIG. 1A to 1C, the coin changing system 1 comprises a detecting apparatus 12, a separable apparatus 14, a base plate 18, and a coin-plucking apparatus 16; wherein the detecting apparatus 12, the separable apparatus 14, and the coin-plucking apparatus 16 are configured on the base plate 18 respectively.

The detecting apparatus 12 further comprises a light-emitting unit 122, a photo sensing unit 124, and an operation unit 126. The light-emitting unit 122 and the photo sensing unit 124 of the present invention generally refer to a light-emitting electronic component and an electronic component capable of outputting an electronic signal while sensing light respectively; and the operation unit 126 generally refers to an electronic component capable of operating electronic signals. More specifically, the light-emitting unit 122 and the photo sensing unit 124 in the embodiment are a light emitting diode module and a photoresistor respectively; and the operation unit 126 in the embodiment is a central processing unit (CPU); wherein the separable apparatus 14 is interconnected with the detecting apparatus 12.

In actual application, the light-emitting unit 122 of the detecting apparatus 12 may generate and emit a light beam 3 toward the vertical direction of the surface where the light-emitting unit 122 is configured after receiving electrical energy, so as to allow the light beam 3 to enter the separable apparatus 14. The separable apparatus 14 comprises an accommodating module 142, a reflection module 144, and a light-guiding module 146.

After the light beam 3 enters the separable apparatus 14, the light-guiding module 146 of the separable apparatus 14 guides the light beam 3 to the accommodating module 142; subsequently, if the position in the accommodating module 142 where corresponds to the light-outputting end of the light-guiding module 146 does not accommodate coins, the light beam 3 may penetrate the accommodating module 142 to reach the reflection module 144; and then, the reflection module 144 may reflect the light beam 3 to return into the light-guiding module 146; furthermore, the light beam 3 may be guide into the photo sensing unit 124 of the detecting apparatus 12. Accordingly, the photo sensing unit 124 may generate and output a corresponding sensing signal to the operation unit 126 so as to judge whether there are coins in the accommodating module 142. On the contrary, if the photo sensing unit 124 does not sense the light beam 3, the optical path of the light beam 3 is blocked by coins; thus the stock of coins in the accommodating module 142 can be judged.

The light-guiding module 146 of the separable apparatus 14 generally refers to the components used for building an optical interconnection between the light-emitting unit 122, the accommodating module 142 and the photo sensing unit 124. As shown in FIGS. 2B and 2C, the light-guiding module 146 comprises a first light-guiding element 1462 and a second light-guiding element 1464; wherein the first light-guiding element 1462 is utilized for guiding the light beam 3 from the light-emitting unit 122 into the reflection module 144, and the second light-guiding element 1464 is utilized for guiding the light beam 3 outputted from the reflection module 144 into the photo sensing unit 124. Moreover, each light-guiding module 146 has a corresponding reflective structure which is capable of changing the traveling direction of the light beam 3. In the embodiment, the first light-guiding element 1462 and the second light-guiding element 1464 are light guiding rods, but not limited to this shape; the light-guiding module 146 may be optical fiber elements according to demands. Besides, the light-inputting end and the light-outputting end of the first light-guiding element 1462 and the second light-guiding element 1464 respectively have a focusing structure 148. Therefore, the light beam 3 can be focused by the focusing structure 148, even when dust particles deposit on part of the light-inputting end or the light-outputting end. Additionally, the focusing structure 148 generally refers to a translucent surface. To be noticed, the first light-guiding element 1462 and the second light-guiding element 1464 can be substituted by any other element which possesses the same functions of the both light-guiding element 1462 and 1464 at the same time. Moreover, the stretching orientation of the first light-guiding element 1462 or the second light-guiding element 1464 is the same with the stacking direction of the coins accommodated within the accommodating module 142.

Furthermore, the accommodating module 142 of the present invention is utilized for accommodating the plurality of coins and has a lateral wall portion 1426, an inlet end 1422, and an outlet end 1424; wherein the inlet end 1422 is an end for the coins to enter the accommodating module 142, the outlet end 1424 is another end for outputting the coins, and the lateral wall portion 1426 is formed between and adjacent to the inlet end 1422 and the outlet end 1424. In the embodiment, the accommodating module 142 is a replaceable hollow tube, but it is not limited thereto. With replacing the hollow tube, the accommodating module 142 may be capable of accommodating different sizes of coins; wherein the material of the accommodating module 142 may be a transparent material or a nontransparent material. When the material of the accommodating module 142 is nontransparent, the positions in the accommodating module 142 correspond to the positions of the light-guiding module 146 and the reflection module 144 may respectively have a corresponding via hole or a depression, so as to allow the light beam 3 to pass through.

The reflection module 144 is configured on the surface of the accommodating module 142 for building an optical interconnection between the first light-guiding element 1462 and the second light-guiding element 1464. In this embodiment, the reflection module 144 has two reflecting surfaces at 45° to each other, and the level heights of the two reflecting surfaces correspond to the first light-guiding element 1462 and the second light-guiding element 1464 respectively; wherein the level heights of the two reflecting surfaces are the same, so that the light beam 3 may be outputted at an angle parallel to the incident direction thereof. However, the angles and the relative position of the two reflecting surfaces can be predetermined by users. Accordingly, the light beam 3 may penetrate the accommodating module 142 and return into the second light-guiding element 1464 of the light-guiding module 146. In the embodiment, the reflection module 144 is an optical component one-piece formed from plastic material.

More specifically, the light-emitting unit 122 of the detecting apparatus 12 may generate and emit a light beam 3 toward the vertical direction of the surface where the light-emitting unit 122 is configured after receiving electrical energy. Subsequently, the light beam 3 may enter the first light-guiding element 1462 from the light-inputting end, and then the light beam 3 may be reflected by the reflective structure configured at the end of the first light-guiding element 1462, so as to output the light beam 3 to the accommodating module 142 through the light-outputting end. After the light beam 3 enters the accommodating module 142, the light beam 3 may penetrate the accommodating module 142 to reach the reflection module 144 when the position in the accommodating module 142 where corresponds to the light-outputting end of the light-guiding module 146 does not accommodate coins.

And then, the light beam 3 may enter the reflection module 144 and be reflected by the two reflecting surfaces, so that the light beam 3 may be outputted from the reflection module 144 at an angle parallel to the incident direction thereof; after this, the light beam 3 may penetrate the accommodating module 142 and return into the light-inputting end of the second light-guiding element 1464, and the reflective structure of the second light-guiding element 1464 may change the traveling direction of the light beam 3 vertically to allow the light beam 3 to be outputted from the light-outputting end, thus the photo sensing unit 124 may receive the light beam 3.

After the photo sensing unit 124 senses the light beam 3, the position in the accommodating module 142 where corresponds to the light-inputting end of the first light-guiding module 1462 can be judged to be without any coins accommodated in. On the contrary, if the photo sensing unit 124 does not sense the light beam 3, the optical path of the light beam 3 is blocked by coins; thus the stock of coins in the accommodating module 142 can be judged. In addition, the traveling direction of the light beam 3 outputted from the first light-guiding module 1462 and entering into the second light-guiding element 1464 is perpendicular to the moving direction of the light beam 3 generated from the light-emitting unit 122.

Compared with the prior art, all the electronic devices of the present invention can be configured within the detecting apparatus 12 (in the prior art, the photo sensing unit 124 is configured at the lateral wall portion 1426 of the accommodating module 142). In the embodiment, the separable apparatus 14 does not comprise any electronic devices or movable elements; therefore, the present invention simplifies the installation or removal process of the separable apparatus 14. Besides, the light-emitting unit 122 and the operation unit 126 in the present invention are configured within the detecting apparatus 12, saving more space to contain more accommodating module 142 than the conventional systems. Furthermore, the unique design of the present invention is capable of sensing the coin storing condition of each of the plurality of the accommodating modules 142 arranged in the matrix form of more than 2 rows and 2 columns.

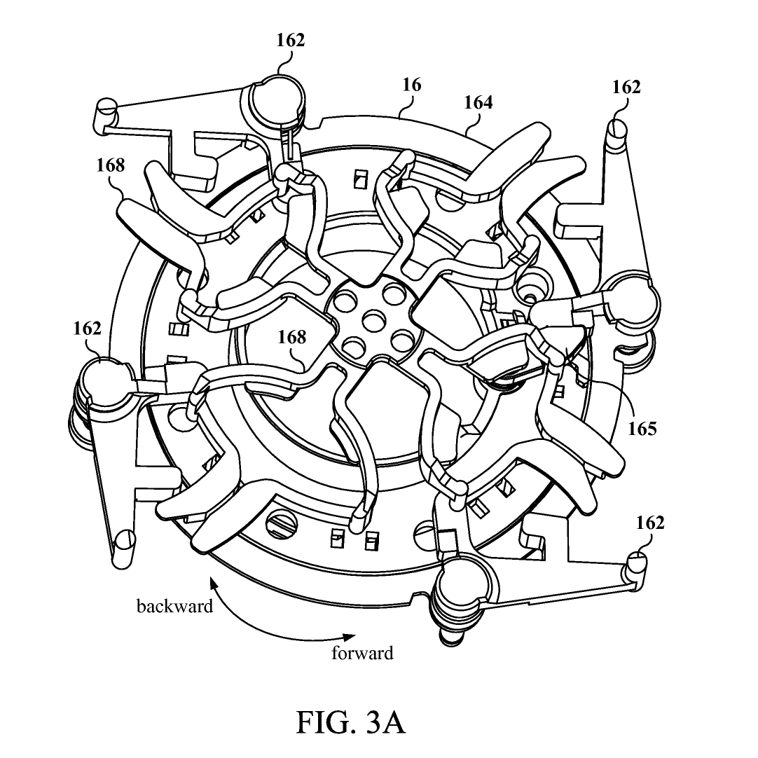

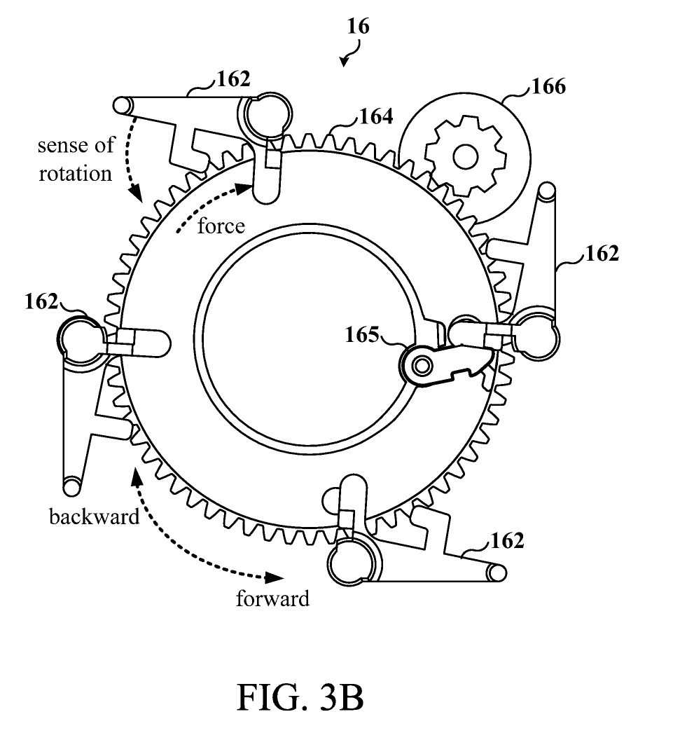

Moreover, the coin changing system 1 of the present invention further comprises a coin-plucking apparatus 16. Please refer to FIGS. 3A and 3B. FIG. 3A is a schematic diagram illustrating the relative position of the coin-plucking apparatus and the guiding component according to an embodiment of the present invention; and FIG. 3B is a schematic diagram illustrating the operation of the coin-plucking apparatus according to an embodiment of the present invention.

As shown in FIGS. 3A and 3B, the coin-plucking apparatus 16 is configured under the separable apparatus 14 and tightly jointed with the accommodating modules 142; wherein the coin-plucking apparatus 16 comprises a plurality of plucking bars 162, a wheel disk 164, a backstop structure 165 and a power module 166.

In the embodiment, the power module 166 is connected with the wheel disk 164 and used for providing a torque to the wheel disk 164, and the plucking bars 162 is utilized for plucking the coins inside the accommodating modules respectively. More specifically, the power module 166 is a transmission apparatus having at least one motor. To be noticed, the power module 166 can control the rotational direction of the wheel disk 164; when the wheel disk 164 rotates forward to allow the backstop structure 165 to be contacted with the coin-plucking apparatus 16 and the wheel disk 164 simultaneously, the backstop structure 165 has a corresponding actuation so as to let the plucking bars 162 be motionless; when the wheel disk 164 rotates backward to allow the backstop structure 165 to be contacted with the coin-plucking apparatus 16 and the wheel disk 164 simultaneously, the plucking bars 162 is engaged with the wheel disk 164 through the backstop structure 165.

More specifically, the backstop structure 165 mentioned above is a flexible linkage which permits only one-way swinging; that is to say, when the wheel disk 164 rotates forward, the backstop structure 165 configured on the wheel disk 164 may be swung backward to let the plucking bars 162 pass through and remain motionless. In order to maintain the stability of the plucking bars 162, the plucking bars 162 further comprises a spring (not shown in the figures) to offset the force applied by the backstop structure 165; and the backstop structure 165 may be returned by resilience.

When the wheel disk 164 rotates backward, the backstop structure 165 configured on the wheel disk 164 may apply a force F to the plucking bars 162, and meanwhile, the plucking bars 162 is engaged with the wheel disk 164 through the backstop structure 165. Accordingly, the coin-plucking apparatus 16 may be capable of plucking the coins inside each accommodating module 142 by using only one power module 166; at the same time, the size of the coin changing system 1 of the present invention can be minimized.

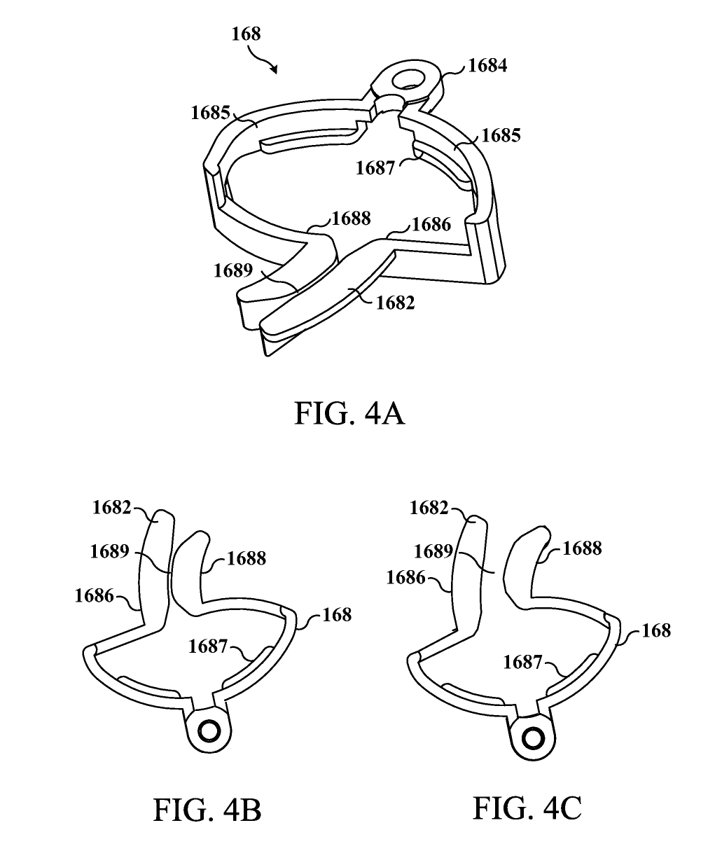

In the prior art, coins often got stuck in the conventional coin changing system; therefore, the present invention adopts a novel guiding component to overcome this problem. Please refer to FIG. 2A to 2C and FIG. 4A. FIG. 4A is a schematic diagram illustrating the guiding component according to an embodiment of the present invention. As shown in FIG. 2A to 2C and FIG. 4A, the guiding component 168 is configured on the base plate 18 of the outlet end 1424 of the accommodating module 142. The guiding component 168 comprises a bearing surface 1682, a connecting structure 1684, a first extension structure 1686, a second extension structure 1688 and a passage 1689.

The bearing surface 1682 generally refers to the contact surface between the guiding component 168 and the coins, and the bearing surface 1682 is used for bearing coins. The first extension structure 1686 and the second extension structure 1688 are extended outward from the connecting structure 1684; moreover, the passage 1689 is formed between the first extension structure 1686 and the second extension structure 1688 to permit a plucking bar 162 to pass through and pluck the coins on the bearing surface 1682; wherein the guiding component 168 has a closure condition and an opening condition.

Please refer to FIGS. 4B and 4C. FIG. 4B is a schematic diagram illustrating the guiding component in the closure condition according to an embodiment of the present invention; and FIG. 4C is a schematic diagram illustrating the guiding component in the opening condition according to an embodiment of the present invention.

When the one end of the plucking bar 162 is not located between the first extension structure 1686 and the second extension structure 1688, the guiding component 168 is in the closure condition; and meanwhile, the width of the passage 1689 is less than the width of the plucking bar 162 so as to prevent the plurality of coins from falling down into the accommodating module 142 and getting jammed.

On the other hand, when the one end of the plucking bar 162 is located between the first extension structure 1686 and the second extension structure 1688, the guiding component 168 is in the opening condition; and the plucking bar 162 is contacted with the first extension structure 1686 and the second extension structure 1688 so as to make the width of the passage 1689 larger than the width in the closure condition thereof. More specifically, the width of the passage 1689 represents the minimum distance between the first extension structure 1686 and the second extension structure 1688.

Additionally, the connecting structure 1684 of the guiding component 168 further comprises a horizontal withstanding portion 1685 and a vertical withstanding portion 1687. The horizontal withstanding portion 1685 is used for providing a horizontal force to the lateral wall portion 1426 of the accommodating module 142; and the vertical withstanding portion 1687 is used for providing a vertical force to the outlet end 1424 to support the accommodating module 142, wherein the vertical withstanding portion 1687 has a bottom surface 1683.

Furthermore, the guiding component 168 further comprises a coin-outputting space for outputting the coin. The coin-outputting space is configured under the connecting structure 1684 and at the corresponding level height of the first extension structure 1686 and the second extension structure 1688. In addition, in order to prevent the guiding component 168 from deformation during bearing coins, the first extension structure 1686 and the second extension structure 1688 have a bottom surface 1683 respectively on the other surface corresponding to their bearing surface 1682. Besides, the bottom surface 1683 is contacted with the base plate 18 so as to transmit and disperse the force applied by coins to the base plate 18.

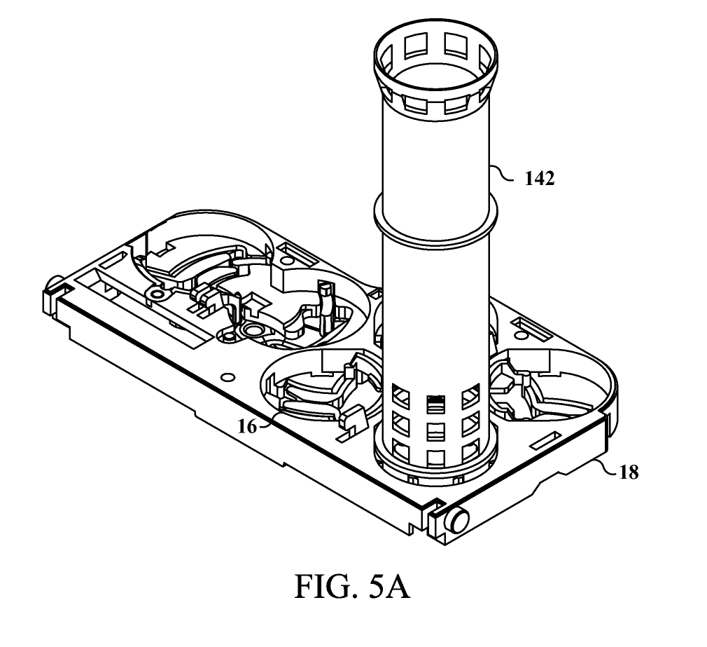

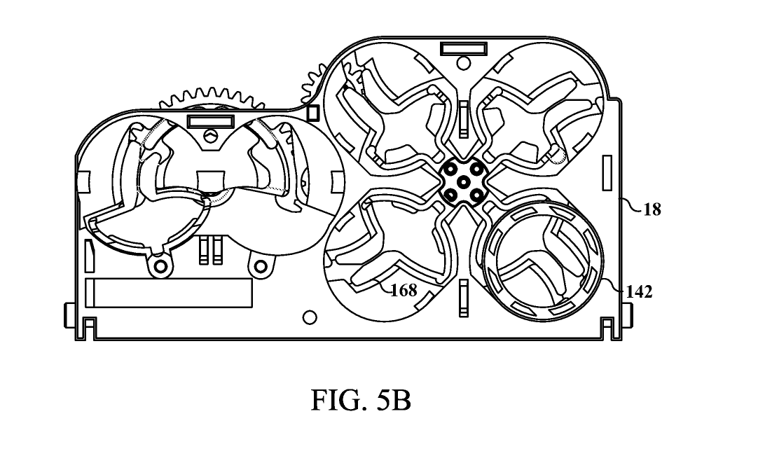

Please refer to FIGS. 5A and 5B. FIGS. 5A and 5B are a schematic diagram and a top view illustrating the relative position of each main component respectively according to an embodiment of the present invention; wherein the components mentioned previously and the components in this embodiment are in essence the same, thus each component need not be elaborate any further.

According to the above, the coin changing system of the present invention is capable of sensing the coin storing condition of each of the plurality of the accommodating modules arranged in the matrix form of more than 2 rows and 2 columns simultaneously. Furthermore, the unique design of the guiding component of the present invention is capable of avoiding the coins from getting jammed during the accommodating process thereof. Nevertheless, the present invention requires only one single motor to deal the coins of each of the plurality of the accommodating modules so as to minimize the size of the coin changing system of the present invention.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. A coin changing system, used for accommodating and changing a plurality of coins, comprising:
a detecting apparatus, comprising:
a light-emitting unit for generating a light beam;
a photo sensing unit for sensing the light beam and generating a corresponding sensing signal; and
an operation unit for judging the stock of coins in accordance with the sensing signal; and
a separable apparatus interconnected with the detecting apparatus, comprising:
an accommodating module for accommodating the plurality of coins;
a light-guiding module for building an optical interconnection between the light-emitting unit and the photo sensing unit; and
a reflection module configured on the accommodating module, used for changing the traveling direction of the light beam to allow the light beam to be returned into the light-guiding module.

2. The coin changing system of claim 1, wherein the light-guiding module comprises:
a first light-guiding element for guiding the light beam from the light-emitting unit into the reflection module; and
a second light-guiding element for guiding the light beam outputted from the reflection module into the photo sensing unit.

3. The coin changing system of claim 2, wherein the first light-guiding element and the second light-guiding element have a light-inputting end for receiving the light beam, and the light-inputting end has a focusing structure.

4. The coin changing system of claim 2, wherein the first light-guiding element and the second light-guiding element have a light-outputting end for outputting the light beam, and the light-outputting end has a focusing structure.

5. The coin changing system of claim 2, wherein the stretching orientation of the first light-guiding element or the second light-guiding element is the same with the stacking direction of the plurality of coins.

6. A coin changing system, used for accommodating and changing a plurality of coins, comprising:
a plurality of accommodating modules for accommodating the plurality of coins respectively; and
a coin-plucking apparatus comprising:
a plurality of plucking bars for plucking the coins inside the accommodating modules respectively;
a wheel disk;
a backstop structure for jointing the plucking bars and the wheel disk; and
a power module connected with the wheel disk, used for providing a torque to the wheel disk;
wherein when the wheel disk rotates forward to allow the backstop structure to be contacted with the coin-plucking apparatus and the wheel disk simultaneously, the backstop structure has a corresponding actuation so as to let the plucking bars be motionless; when the wheel disk rotates backward to allow the backstop structure to be contacted with the coin-plucking apparatus and the wheel disk simultaneously, the plucking bars is engaged with the wheel disk through the backstop structure.

7. A coin changing system, used for accommodating and changing a plurality of coins, comprising:
an accommodating module for accommodating the plurality of coins, having a lateral wall portion, an inlet end, and an outlet end;
a guiding component configured at the outlet end, having:
a bearing surface used for bearing a coin;
a connecting structure;
a first extension structure extended outward from the connecting structure;
a second extension structure extended outward from the connecting structure; and
a passage formed between the first extension structure and the second extension structure to permit a plucking bar to pass through and pluck the coin;
wherein the guiding component has a closure condition and an opening condition;
in the closure condition, the width of the passage is less than the width of the plucking bar so as to prevent the plurality of coins from falling down; in the opening condition, the plucking bar is contacted with the first extension structure and the second extension structure so as to make the width of the passage larger than the width in the closure condition thereof

8. The coin changing system of claim 7, wherein the connecting structure of the guiding component further comprises:
a horizontal withstanding portion for providing a horizontal force to the lateral wall portion of the accommodating module.

9. The coin changing system of claim 7, wherein the connecting structure of the guiding component further comprises:
a vertical withstanding portion for providing a vertical force to the outlet end of the accommodating module, and the vertical withstanding portion has a bottom surface.

10. The coin changing system of claim 7, wherein the guiding component further comprises a coin-outputting space for outputting the coin, the coin-outputting space is configured under the connecting structure and at the corresponding level height of the first extension structure and the second extension structure.
